(19) United States
(12) Patent Application Publication
(10) Pub. No.: US 2010/0318489 A1
(43) Pub. Date: Dec. 16, 2010

(54) PII IDENTIFICATION LEARNING AND INFERENCE ALGORITHM

(75) Inventors: MARCELO DE BARROS, Redmond, WA (US); MANISH MITTAL, Sammamish, WA (US); HUI SHI, Redmond, WA (US); MARZI E. DAMANIA, Kirkland, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/482,915

(22) Filed: Jun. 11, 2009

(51) Int. Cl. G06N 5/04; G06F 17/30

(52) U.S. Cl. 706/50; 707/E17.045

(57) ABSTRACT

Techniques are described herein for determining whether data sets of real information in databases indicate PII information. The data sets are stored in a first table and parsed for keywords related to the names of data items in the sets. The keywords are stored in the second table in a many-to-many relationship with related data items in the first table. The number of times the keywords are parsed from the data items is counted, as well as the number of times each keyword is associated with a PII-designated data item. The counted numbers are then used in analyzing new data sets to identify the likelihood that the new data sets contain any PII data items.

### BACKGROUND

Information about people is currently being stored in database structures capable of holding massive amounts of digital data. These databases and services often need to be tested for various reasons. Real production data improves the results of database testing more than generated test data by catching problems normally missed when using generated data. Although, real data may contain sensitive information that should not be shared beyond a specific database or online service—information like a social security number (SSN), personal identification number (PIN), password, account number, and so forth. Obtaining actual database data for testing therefore requires identification of all sensitive information in a data set and obfuscation of that data before being shared. Traditionally, the identification of sensitive data in a database is performed manually. For example, a person typically has to review a list of the data and designate a particular data item or group of data items as private. While database items can be enormously helpful for testing purposes, it is paramount that databases protect the privacy of all sensitive data items.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

One aspect of the invention is directed to determining whether data sets of real information in databases indicate personal identification information (PII). The data sets are parsed to uncover data-entry names, data types, primary key identifiers, PII identifiesr, and sanitization functions. Specifically, the name of the data item is parsed for keywords, and the keywords are kept in table. A counter tracks the number of times each keyword occurs—or was parsed from a data item. Another counter tracks the number of times each keyword is associated with a data item designated as a PII. The counter's calculations are stored as PII statistics and used to infer whether a new data set from a database likely contains any PII entries. Another aspect is directed to a database server configured to perform the aforesaid techniques using at least a learning application and an inference application.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary computing device, according to one embodiment;

FIG. 2 is a block diagram of a networking environment capable of identifying certain types of information in database tables, according to one embodiment;

FIG. 3 is a block diagram of different database tables, according to one embodiment;

FIG. 4 is a diagram of a flow chart for analyzing data entries in tables from databases, according to one embodiment; and

FIG. 5 is a diagram of a flow chart for predicting what the types of entries are in a new data set of a database, according to one embodiment.

### DETAILED DESCRIPTION

The subject matter described herein is presented with specificity to meet statutory requirements. The description herein is not intended, however, to limit the scope of this patent. Instead, the claimed subject matter may also be embodied in other ways, to include different steps or combinations of steps similar to the ones described in this document, in conjunction with other present or future technologies.

In general, embodiments described herein are directed to techniques for learning from real production data what database entries typically constitute as PII and, based on such learning, predicting whether new data sets contain PII entries. The techniques described herein may be thought of as two separate phases: a learning phase and an inference phase.

During the learning phase, an administrator designates data entries in tables of production data sets as PII or non-PII entries. Each data entry is parsed into keywords, and the keywords are assigned the same PII designation as the data entry from which the keywords were parsed. A learning application (described in more detail below) counts (1) the number of times a keyword occurs in all the data entries and (2) the number of times the keyword is designated as a PII. During the inference phase, the PII statistics (i.e., the two numbers) about the data analyzed in the learning phase are used to ascertain whether data entries in a new data set contain any PII entries.

As to terminology, PII information refers to data items that uniquely identify individuals, accounts of individuals, or the other sensitive data about individuals. Examples of PII information include, without limitation, a social security number (SSN), personal identification number (PIN), date of birth (DOB), account numbers, and so forth. This category can also include pseudonymous identifiers (e.g., various unique identifiers). In certain cases, PII may need to be obfuscated by applying a sanitization function in order to be transferred safely.

The term “sanitization” and “obfuscation” should be construed broadly herein. Sanitization refers to any modification of restricted data items in a manner that conceals some characteristic of the data items to an unauthorized party. In one technique, sanitization functions can completely randomize PII data items such that these items no longer convey any intelligible information. This can be performed by replacing the restricted data items with random strings of alphanumeric characters (“RandomSting” sanitization). In another technique, sanitization functions can replace restricted data items with information that is per se intelligible, but fails to otherwise provide enabling confidential information that can be used for nefarious ends. This can be performed, for instance, by scrambling record items in a database, or by substituting fictitious entries for certain pieces of restricted data items. As a result of these measures, it is not possible for an unauthorized party to reconstruct complete records and use the records to the disadvantage of the account holders.

Whatever functions are used, the sanitization functions described herein preferably conceal PIIs in production data sets, while, at the same time, preserve as much of the state of the original production data set as possible. As used herein, “state” refers to the attributes or features of records in the data set. For example, assume that a record indicates that an individual with SSN 1234-56-7890 subscribes to two online services offered by a particular company. The sanitization functions would modify the SSN of the individual such that the sanitized data set does not reveal the actual numbers, at least in connection with this particular record. The sanitization functions might otherwise attempt to preserve certain features of this record, such as the fact there is someone registered with the two online services. When obfuscating SSN numbers, sanitization functions might also attempt to preserve certain statistical features by storing the data type (e.g., integer, string, etc.) of the stored SSN.

The term “data set” refers to a stored collection of data items. A data set may be restricted to a particular repository of data items, such as a particular database maintained by a particular server. Or the data set may encompass records maintained by several different repositories of data items, possibly maintained by several different servers. Where the data set derives from particular repositories of data items, it may include all of the records in those repositories, or only some subset thereof. The repositories can include any possible source of data items, such as databases, flat files, comma separated value (CSV) files, and so forth.

Embodiments discussed herein make repeated reference to operations performed “on” the “production data set(s)” or “new data set.” The software operations mentioned herein may perform operations on copies of the production data set or new data set, or some portion thereof, leaving original copies of the production data sets or new data set intact for other operations.

Generally, the operations and steps described herein can be implemented using software, firmware (e.g., fixed logic circuitry), manual processing, or a combination of these implementations. The terms “module,” “component” “functionality,” and “logic” as used herein generally represent software, firmware, or a combination of software and firmware. In the case of a software implementation, the terms “module,” “component,” “functionality,” or “logic” represent program code that performs specified tasks when executed on a processing unit or units (e.g., CPU or CPUs). The program code can be stored in one or more fixed or removable computer-readable media. The memory can be provided at one site or several sites in distributed fashion.

Computer-readable media include both volatile and nonvolatile media, removable and nonremovable media, and contemplates media readable by a database. The various computing devices, application servers, and database servers described herein each may contain different types of computer-readable media to store instructions and data. Additionally, these devices may also be configured with various applications and operating systems.

By way of example and not limitation, computer-readable media comprise computer-storage media. Computer-storage media, or machine-readable media, include media implemented in any method or technology for storing information. Examples of stored information include computer-useable instructions, data structures, program modules, and other data representations. Computer-storage media include, but are not limited to, random access memory (RAM), read-only memory (ROM), electrically erasable programmable read-only memory (EEPROM), flash memory used independently from or in conjunction with different storage media, such as, for example, compact-disc read-only memory (CD-ROM), digital versatile discs (DVD), holographic media or other optical disc storage, magnetic cassettes, magnetic tape, magnetic disk storage, or other magnetic storage devices. These memory devices can store data momentarily, temporarily, or permanently.

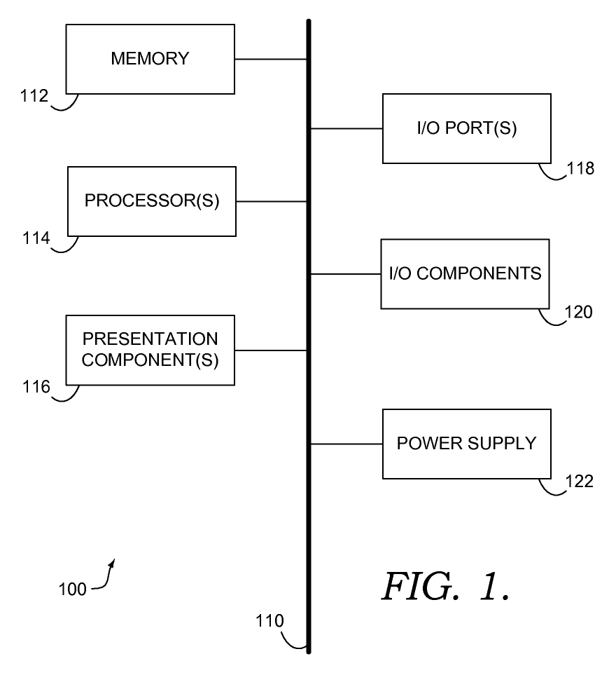

Having briefly described a general overview of the embodiments described herein, an exemplary operating environment is described below. Referring initially to FIG. 1 in particular, an exemplary operating environment for implementing one embodiment is shown and designated generally as computing device 100. Computing device 100 is but one example of a suitable computing environment and is not intended to suggest any limitation as to the scope of use or functionality of the invention. Neither should computing device 100 be interpreted as having any dependency or requirement relating to any one or combination of illustrated component parts. In one embodiment, computing device 100 is a personal computer. But in other embodiments, computing device 100 may be a cell phone, smartphone, digital phone, handheld device, BlackBerry®, personal digital assistant (PDA), or other device capable of executing computer instructions.

Embodiments may be described in the general context of computer code or machine-useable instructions, including computer-executable instructions such as program modules, being executed by a computer or other machine, such as a PDA or other handheld device. Generally, machine-useable instructions define various software routines, programs, objects, components, data structures, remote procedure calls (RPCs), and the like. In operation, these instructions perform particular computational tasks, such as requesting and retrieving information stored on a remote computing device or server.

Embodiments described herein may be practiced in a variety of system configurations, including handheld devices, consumer electronics, general-purpose computers, more specialty computing devices, etc. Embodiments described herein may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation device 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various hardware is not so clear, and metaphorically, the lines would more accurately be grey and fuzzy. For example, one may consider a presentation device, such as a monitor, to be an I/O component. Also, processors have memory. It will be understood by those skilled in the art that such is the nature of the art, and, as previously mentioned, the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computing device.”

Computing device 100 may include a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, or any other tangible computer-readable medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, cache, optical-disc drives, etc. Computing device 100 includes one or more processors that read data from various entities such as memory 112 or I/O components 120. Presentation device 116 presents data indications to a user or other device. Exemplary presentation components include a display device, speaker, printing component, vibrating component, etc.

Specifically, memory 112 may be embodied with instructions for a web browser application, such as Microsoft Internet Explorer®. One skilled in the art will understand the functionality of web browsers; therefore, web browsers need not be discussed at length herein. It should be noted, however, that the web browser embodied on memory 112 may be configured with various plug-ins (e.g., Microsoft SilverLight™ or Adobe Flash). Such plug-ins enable web browsers to execute various scripts or mark-up language in communicated web content. For example, a JavaScript may be embedded within a web page and executable on the client computing device 100 by a web browser plug-in.

I/O ports 118 allow computing device 100 to be logically coupled to other devices including I/O components 120, some of which may be built in. Illustrative components include a microphone, joystick, game pad, satellite dish, scanner, printer, wireless device, etc.

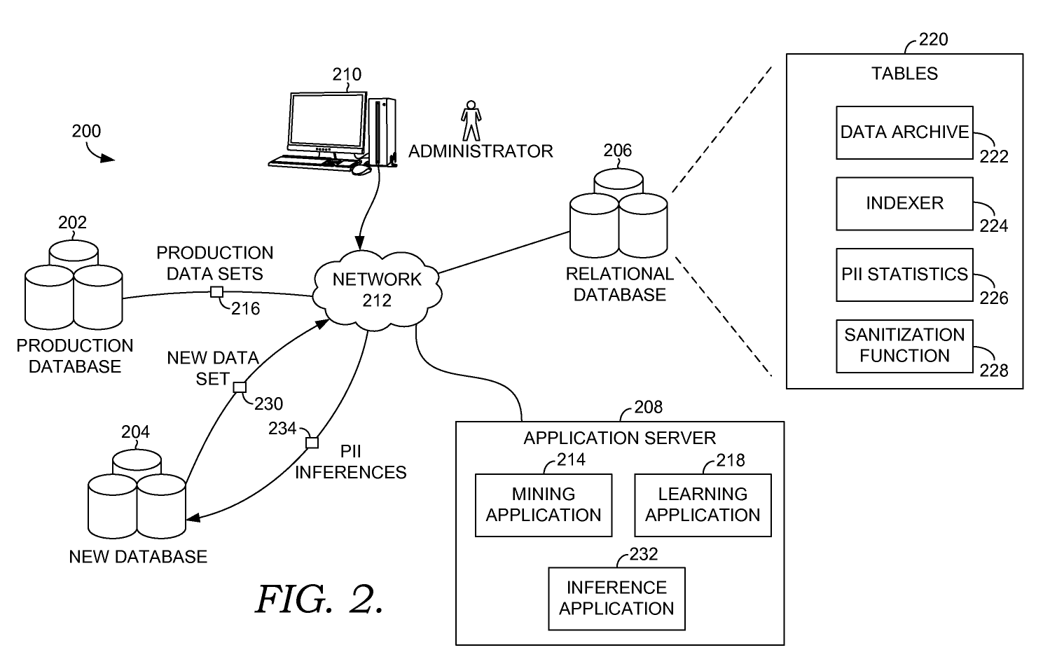

FIG. 2 is a block diagram of a networking environment 200 capable of identifying certain types of information in database tables, according to one embodiment. The networking environment 200 comprises different computing devices, notably several database clusters (production database 202, new database 204, and relational database 206), application server 208, and client computing device 210. These computing devices communicate with each other over network 212. Other embodiments may alternatively include different computing devices than those shown in the networking environment 200.

Production database 202, new database 204, and relational database 206 each represent one or more database servers configured to store data items in various forms. One skilled in the art will appreciate that each database server may include a processing unit, computer-readable media, and database-server software, such as Microsoft SQL Server®. One skilled in the art will appreciate that applications developed in database computer languages may be designed for the management of data in relational database management systems (or “RDBMS”). In particular, relational database 206 operates an RDBMS to associate data items in various stored tables with data items in other stored tables.

The application server 208 represents a server (or servers) configured to execute different software applications. Application server 208 includes a processing unit and computer-readable media storing instructions to perform the techniques of mining application 214, learning application 218, and inference application 232. While application server 208 is illustrated as a single box, one skilled in the art will appreciate that the application server 208 may be scalable. For example, application server 208 may actually include multiple servers operating various portions for mining application 214, learning application 218, and inference application 232. Alternatively, application server 208 may act as a broker or proxy server for mining application 214, learning application 218, and inference application 232. Application server 208 can access data tables 220 stored in the relational database cluster 206. In one embodiment, the application server 208 executes the learning and inference phases referred to herein.

While mining application 214, learning application 218, and inference application 232 are illustrated within the application server 208, these applications do not necessarily need to function “in the cloud.” Any of the applications may, in alternative embodiments, be executed on the databases themselves. For example, the applications shown within application server 208 may be embodied on computer-storage devices and executed by processors of the production database 202, new database 204, or relational database 206.

Client computing device 210 may be any type of computing device, such as the computing device 100 described above with reference to FIG. 1. By example, without limitation, client computing devices 210 may each be a personal computer, desktop computer, laptop computer, handheld device, mobile phone, or other personal computing device. An administrator uses computing device 210 to access and manipulate different data items or data sets in the relational database 206. Specifically, the administrator can designate data items in the relational database as PIIs or not.

The network 212 may include any computer network, for example the Internet, a private network, local area network (LAN), wide area network (WAN), or the like. When network 212 comprises a LAN networking environment, components may be connected to the LAN through a network interface or adaptor. In an embodiment where the network 212 provides a LAN networking environment, components may use a modem to establish communications over the WAN. The network 212 is not limited, however, to connections coupling separate computer units. Instead, the network 212 may also include subsystems that transfer data between computing devices. For example, the network 212 may include a point-to-point connection. Computer networks are well known to one skilled in the art, and therefore do not need to be discussed at length herein.

In operation, the devices illustrated in the networking environment 200 work to understand the data items stored in the production database 202 so that inferences can accurately be made as to data items in other databases containing PII. In particular, the production database 202 submits production data sets 216 to the application server 208. Alternatively, the application server 208 may request the production data sets 216 from the production database 202 and receive the production data sets 216 upon request. In other words, the production data sets 206 may be pushed, pulled, or pushed then pulled to the application server 208.

The production data sets 216 comprise numerous tables of data items stored in the production database 202. In one embodiment, the tables are stored as extensible markup language (XML) files. One skilled in the art will understand that various techniques are available for storing data items in database structures. Again, though, other techniques may be used to store data items in data sets. Moreover, the production data sets 216 include real-world data from the production database 202.

The application server 208 executes multiple software applications, including mining application 214, learning application 218, and inference application 232. The mining application 214 operates to extract data items from production data sets 216 and store the data items in various tables 220 maintained by the relational database 206. For each data item in the production data sets 216, the mining application 214 extracts a name, data type, a primary key identifier, a PII identifier, a sanitization function assigned to the data item, and other relevant information. The primary key identifier represents a designation of whether a data item is allowed to have duplicates. For example, a data item named SSN (for “social security number”) may be designated as a primary key because of a developer's desire not to have several stored social security numbers in a database. The sanitization function represents the obfuscation technique performed on the data item to obfuscate its contents. Examples of sanitization functions include, without limitation, RandoString, public/private keys, hashes, and so forth. The data type represents the actual stored data type of the data item, such as integer, string, bigint, float, double, char, and so forth. In other embodiments, various other information may additionally be extracted along with the aforesaid.

The information extracted by the mining application 214 is stored in the tables 220 of the relational database 206. Specifically, the following tables are stored: data archive 222, indexer 224, PII statistics 226, and sanitization function 228. The mining application 214 transmits the information extracted from the production data sets 216 (e.g., name, data type, primary key identifier, PII identifier, and sanitation techniques) to the relational database 206 for storage into the data archive 222, which is a table of all the data items found by the mining application 214. The learning application 218, in one embodiment, accesses the information stored in the data archive 222 in order to learn the names of data items that are being marked as PIIs.

The data archive 222 stores extracted data from the production data sets 216 as data items in the relational database 206. For each entry in the data archive 222, a data item name, data type, primary key identifier, PII identifier, and sanitization function are stored. In one embodiment, the administrator, using the client computing device 210, manually looks through the data items of the data archive 222 and specifies which are associated with PII, setting the PII identifier in a certain manner. Other embodiments may set the PII identifier in other ways.

In one embodiment, the learning application 218 extracts keywords from the names of data items stored in the data archive 222. Keywords from a data name can be obtained by identifying delimiters in a particular data item name and extracting the text separated by the delimiters. Delimiters, for example but without limitation, include characters such as underscores, slashes, hyphens, spaces, and any other character used to separate words or abbreviations of words stored as names of data items. For example, a data item name of USER_SSN contains an underscore delimiter, so the learning application 218 may extract keywords USER and SSN from the data item name. Additionally, the learning application 218 can determine keywords for data item names by simply removing the delimiter from a data item name; for instance, USER_SSN could be converted to USERSSN.

Aside from delimiters, the learning application 218 may also determine keywords by recognizing abbreviations in text of data item names. For example, the name ADDY may produce the keyword ADDRESS, because ADDY is a common database abbreviation for address. In one embodiment the learning application 218 accesses an abbreviation table stored on the application server 208 (although not shown for the sake of clarity). Conversely, the learning application 218 may determine that an abbreviation is a keyword of a longer data item name. Looking again at the above example, ADDRESS would be a keyword extracted from the data item name ADDY.

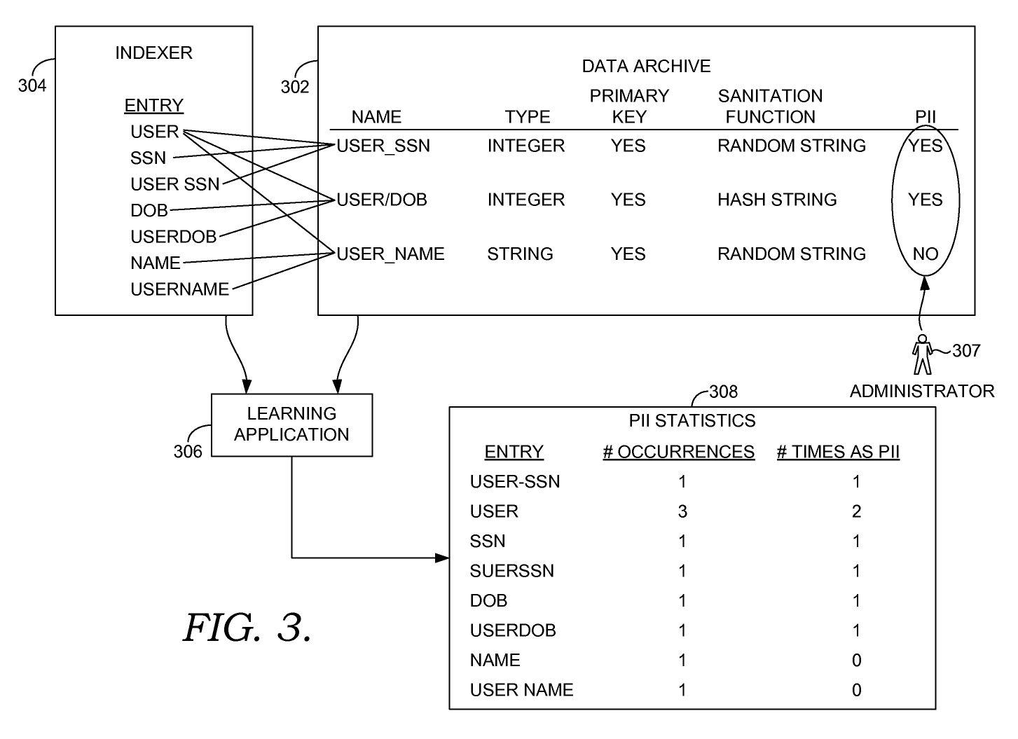

The learning application 218 stores all of the extracted keywords into indexer 224 on relational database 206. A many-to-many relationship mapping is made between the names of data items in the data archive 222 and the keywords extracted therefrom in indexer 224. Specifically, FIG. 3 shows such a relationship mapping more clearly. FIG. 3 shows several listings stored in the relational database 206. Specifically, a data archive 302, indexer 304, and PII statistics 308 table are shown interacting with a learning application 306. In the data archive 302, three different data items are listed. For each data item listed, the data type, primary key identifier, sanitization function, and PII identifier is listed. As illustrated, an administrator 307 can access the data archive 302 and manipulate the PII identifiers. The names of the entries in the data archive 302 have been parsed for keywords, and the keywords are stored in the indexer 304. Specifically USER_SSN was determined to have keywords USER, SSN, and USERSSN. Entry USER/DOB was determined to have keywords USER, DOB, and USERDOB. Entry USER_NAME was determined to have keywords USER, NAME, and USERNAME.

Learning application 306 analyzes the information stored in data archive 302 and indexer 304. In operation, the learning application 306 uses counters to determine how many times a keyword has been associated with a data item in the data archive 302. For example, the keyword USER was associated with three different data items; therefore, a counter in the learning application 306 would register three occurrences of USER. Also, the counters in the learning application 306 track the number of times a keyword is associated with a data item that is indicated to be a PII. These statistics are stored in the PII statistics 308 table. Although not shown in FIG. 3, another counter may also be configured to identify the number of times a keyword in the indexer 304 is associated with a specific sanitization function.

Turning back to FIG. 2, the inference application 232 uses a stochastic approach to, given a new data set 230, determine whether data entries can be considered PII based on the information stored in tables 220. The inference application 232, in one embodiment, also computes a competence score (or “likelihood”) that a particular data item in the new data set 230 is a PII. The inference application 232 then uses the competence scores to make PII inferences 234 that can be transmitted to the new database 204. In other words, the inference application 232 reviews the data items in the new data set 230, determines whether those data items are PIIs based on the information stored in the tables 220, and returns a file that indicates whether those data items are PIIs or not.

The inference application 232 extracts the name, data type, primary key identifier, PII identifier, and sanitization function for each data item in the new data set 230. Keywords for the names of the data items are extracted in the same manner as was performed by the learning application 218 on the production data sets 216. For instance the inference application 232 may parse names for delimiters, abbreviations, and so forth. The keywords of the data items in the new data set 230 are compared against the keywords listed in the indexer 224.

For the sake of clarity, keywords extracted from data items in the new data set 230 are referred to hereafter as “new keywords” to distinguish from the keywords stored in the indexer 224. If a new keyword matches a keyword in the indexer 224, all the data items in the data archive 222 that are associated with the matcher(?) keyword are then accessed. If the indexer 224 keyword is associated with multiple data items in the data archive 222, a ranking is used to determine which of the data items in the data archive 222 is more likely to be associated with the new keyword. To perform the ranking, the inference application 232 computes the following formula:

ranking=0.6*A/B+0.15*C+0.1*D+0.15*E

A equals the number of keywords linked to a data item in the data archive 222—i.e., the number of keywords linked to a name of a data item. B equals the total number of new keywords. C equals one if the data type of the new keyword and the keyword in the indexer 224 matches (e.g., both are integers), and zero otherwise. D equals one if the length of the new keyword and the length of the keyword in the indexer 224 matches; otherwise, D equals zero. E equals one if the data item associated with the new keyword and the data items in the data archive 222 associated with the keyword 224 matching the new keyword are each listed as a primary key. The ranking is calculated for each data item in the data archive 222 that is associated with a keyword in the indexer 224 matching a new keyword.

Ranking values are compared to determine which of the data items in the data archive 222 has the highest ranking, and thus is the best match for the new keyword's data item in the new data set 230. If the ranking values indicate a tie, the tiebreak may be given to the keyword in the indexer 224 having the highest number of times counted as a PII in the PII statistics table 226. Alternatively, a keyword in the indexer 224 may be chosen randomly to break a tie.

When the keyword in the indexer 224 is determined for a new keyword, the best ranked data items in the data archive 222 associated with the determined keyword is accessed. A competence score is computed to determine how likely the data item associated with the new keyword is a PII. To compute this competence score (noted below as “PII confidence Score”), the following formula may be used:

PII confidence score=ranking*E/(E+F)

Ranking refers to the winning ranking score computed. E equals the number of times the keyword in the indexer 224 was associated with a PII data item. F equals the number of times the keyword selected in the indexer 224 was associated with a data item in the data archive 222 that was designated as a PII.

The inference application 232 makes PII inferences about whether or not data items in the new data set 230 are actually PIIs. To make these instances, the inference application 232 checks the PII confidence scores assigned to the data items in the new data set 230. For those scores that are greater than 75%, in one embodiment, the inference application 232 indicates that the associated data item is likely a PII. In another embodiment, when the PII confidence score is between 25% and 75% the associated data item is indicated to maybe be a PII. Those data items associated with PII confidence scores that are lower than 25% are indicated not to be a PII. The PII inferences are packaged into a table or file (e.g., an XML file) and transmitted to the new database 204.

In one embodiment, the inferences returned from the inference application 232 are checked by an administrator of the new database 204 (not shown for clarity). The administrator of the new database 204 may accept or reject the PII inferences, and the administrator's acceptance or rejection can, in some embodiments, be transmitted back to the application server for storage in the relational databases 206. Other ways to instruct the application server 208 or the relational databases 206 of feedback about the PII inferences 234 may also be employed.

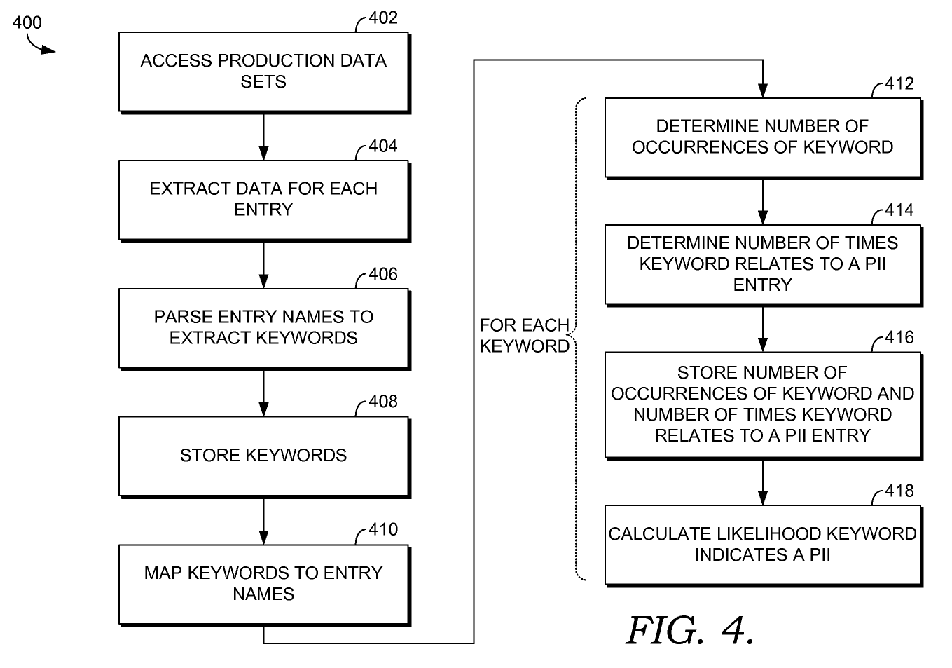

FIG. 4 is a diagram of a flowchart for analyzing data entries in tables from databases, according to one embodiment. Initially, production data sets are accessed, as indicated at 402. From the production data sets, information about data items is extracted, as indicated at 404. Examples of the extracted information include, without limitation, the name, data type, primary key identifier, PII identifier, and sanitization technique associated with a data item. The names of data items are parsed in order to extract keywords, as indicated as 406. The aforesaid techniques for extracting keywords from data item names (e.g., delimiters, abbreviations, and so forth) are used to determine the keywords. The keywords are stored in a table (called “data_archive”), as indicated at 408, and mapped within the table to data items of the production data sets, as indicated at 410. The keywords may be stored in an table (called “indexer”). In one embodiment, the keywords are mapped to entries in a table, such as the data archive table referred to in FIGS. 2 and 3.

For each keyword identified, the following steps are performed. A counter determines the number of times the keyword occurs in the indexer table (# of occurrences), as indicated at 412. In other words, the counter finds out how often the keyword was extracted from a data item in the production data sets. A counter also determines the number of times the keyword is associated with a data item specified to be a PII entry (# seen as PII), as indicated at 414. The # of occurrences and # seen as PII are stored, as indicated at 416 and used to calculate the likelihood the keyword indicates PII information, as indicated at 418.

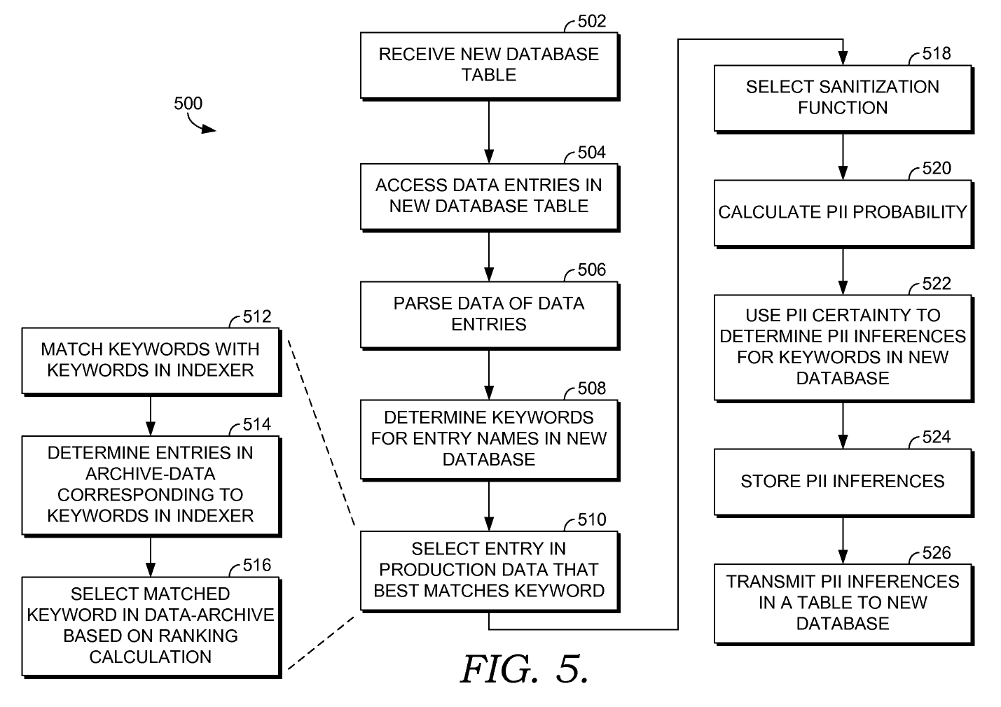

FIG. 5 is a diagram of a flow chart for predicting what the types of entries are in a new data set of a database, according to one embodiment. When a new database table is received (indicated at 502), the data items are accessed (indicated at 504). As shown at 506, the data items are parsed for data, and from the parsed data, keywords are determined for data items in the new database (shown at 506).

For each keyword, data items are selected that best match the keyword, as indicated at 510. To do so, a previously stored table (called “indexer”) is accessed to attempt to match the keyword with the stored keywords in the indexer, as indicated at 512. Data items previously stored in another table (called “data_archiver”) that are associated with the stored keywords are determined, as indicated at 512. If more than one data item in the data_archiver are associated with the keywords, a ranking is calculated to select an optimal data item. The ranking may be performed using the aforementioned formula for calculating rankings, as indicated at 516.

A sanitization function is selected, as indicated at 518. The PII confidence score is calculated for the data item associated with the keyword parsed from the new database table (indicated at 520) and used to determine PII inferences for data items in the new database (indicated at 522). The PII inferences are stored, as indicated at 524, perhaps in an XML table. Finally, the PII inferences are transmitted to the new database, as indicated at 526.

Although the subject matter has been described in language specific to structural features and methodological acts, it is to be understood that the subject matter defined in the appended claims is not necessarily limited to the specific features or acts described above. Rather, the specific features and acts described above are disclosed as example forms of implementing the claims. For example, sampling rates and sampling periods other than those described herein may also be captured by the breadth of the claims.

The invention claimed is:

1. One or more computer-readable media embodied with computer-executable instructions that, when executed by a processor, perform a computer-implemented method for creating and storing multiple tables detailing PII information about at least one data set, comprising:
accessing the at least one data set, the at least one data set comprising data items;
extracting data about each of the data items, wherein the data comprises a name for each of the data items;
storing the data in a first table;
parsing the names into one or more keywords;
storing each of the one or more keywords in a second table;
mapping each of the one or more keywords to each of the data items the one or more keywords was parsed from; and
determining a number of times each of the one or more keywords is associated with a data item specified as a PII.

2. The one or more media of claim 1, wherein the at least one data set is stored in one or more tables.

3. The one or more media of claim 2, wherein the one or more tables are stored as one or more XML files.

4. The one or more media of claim 1, wherein the one or more XML files are stored in a relational database.

5. The one or more media of claim 1, wherein parsing the names into keywords further comprises identifying a delimiter in a name.

6. The one or more media of claim 1, wherein parsing the names into keywords further comprises identifying one or more abbreviations associated with the names.

7. The one or more media of claim 1, further comprising determining a number of times each of the one or more keywords is associated with any of the data items.

8. The one or more media of claim 7, calculating a likelihood each of the one or more keywords indicates a PII based on:
(1) the number of times each of the one or more keywords is associated with any of the data items, and
(2) a number of times each of the one or more keywords is associated with a data item specified as a PII.

9. The one or more media of claim 1, wherein the first table and the second table are related in a many-to-many relationship so the one or more keywords are associated with the data items.

10. The one or more media of claim 1, wherein the data comprises at least one member of a group comprising a data type, primary key identifier, and PII identifier.

11. The one or more media of claim 1, wherein the data comprises at least one sanitization function.

12. A computer-implemented method, comprising:
receiving a database table that includes at least one data set with data items, the data items each comprising a name, data type, and sanitization function;
determining one or more keywords associated with the data items;
determining whether the one or more keywords match any of a plurality of keywords in a first table;
calculating a probability that the one or more keywords are actually a PII based on at least data items associated with the plurality of keywords in the first table; and
storing the probability.

13. The computer-implemented method of claim 12, further comprising:
determining one or more PII inferences based on the probability; and
transmitting the PII inferences to a database.

14. The computer-implemented method of claim 13, wherein the PII inferences indicate at least one of the data items is a PII based on a confidence score being greater than 75%.

15. The computer-implemented method of claim 13, further wherein the PII inferences indicate at least one of the data items is not a PII based on a confidence score being less than 25%.

16. The computer-implemented method of claim 13, further wherein the PII inferences indicate at least one of the data items is not a PII based on a confidence score being between 25-75%.

17. A database server, comprising:
a processor;
one or more computer-readable media, embodied machine-executable instructions that, when executed by the processor, support:
(1) a learning application capable of:
a) analyzing data items stored in a data archive table,
b) determining keywords associated with the data items,
c) using the keywords to compute PII statistics, and
(2) an inference application capable of determining whether a new data set from a new database contains any PII entries.

18. The database server of claim 17, wherein the PII statistics comprise:
a first determination of the number of times each of the keywords was associated with one of the data items; and
a second determination of the number of times each of the keywords was associated with a data item identified as a PII entry.

19. The database server of claim 17, wherein the inference application determines whether the new data set from the new database contains any PII entries by:
computing a ranking by computing 0.6*A/B+0.15*C+0.1*D+0.15*E, wherein:
(1) A equals the number of keywords linked to a data item in the data archive table,
(2) B equals a total number of keywords associated with the new data set,
(3) C indicates whether a new data item and one of the data items are assigned a same data type,
(4) D indicates whether a new keyword has the same length as one of the keywords, and
(5) E indicates whether the new keyword is associated with a new data item that is designated as a primary key.

20. The database server of claim 17, further comprising using the ranking to calculate a PII confidence score.
